(19) United States
(12) Patent Application Publication
(10) Pub. No.: US 2025/0251750 A1
(43) Pub. Date: Aug. 7, 2025

(54) BETA COMPENSATION TECHNIQUE FOR GENERATING A PROCESS, VOLTAGE, AND TEMPERATURE INVARIANT REFERENCE VOLTAGE

(71) Applicant: STMicroelectronics International N.V., Geneva (CH)

(72) Inventors: Atul DWIVEDI, Varanasi (IN); Pradeep Kumar BADRATHWAL, Greater Noida (IN)

(21) Appl. No.: 19/037,167

(22) Filed: Jan. 25, 2025

Related U.S. Application Data
(60) Provisional application No. 63/549,671, filed on Feb. 5, 2024.

(51) Int. Cl. G05F 3/30

(52) U.S. Cl. CPC G05F 3/30

(57) ABSTRACT

A circuit and method for generating a PVT invariant reference voltage are provided. The example circuit includes a reference BJT, wherein a ratio of a collector current at the collector terminal and a base current at the base terminal is equal to a beta value. The example circuit further includes a resistive element having a first terminal and a second terminal, the second terminal electrically coupled to the emitter terminal of the reference BJT. A reference voltage is generated by the example circuit based on a voltage difference between the first terminal of the resistive element and the base of the reference BJT. The example circuit further includes a beta-compensated current generation circuit configured to generate a beta-compensated current, based on a PTAT current, at the emitter terminal of the reference BJT, wherein the beta-compensated current is inversely proportional to the beta value of the reference BJT.

### CROSS-REFERENCE TO RELATED APPLICATION

The present application claims priority to U.S. Provisional Patent Application No. 63/549,671, filed Feb. 5, 2024, the entire contents of which is incorporated herein by reference.

### TECHNOLOGICAL FIELD

Embodiments of the present disclosure relate generally to generating a process, voltage, and temperature (PVT) invariant reference voltage, and more particularly, to compensating for non-linear components the reference voltage generation related to the beta value of the generating bipolar junction transistor.

### BACKGROUND

Bipolar junction transistors (BJTs) are commonly used to generate internal reference voltages on a computing resource. The base-emitter voltage (V_{BE}) extracted from a BJT is complementary-to-absolute-temperature (CTAT). As a CTAT voltage, the base-emitter voltage decreases near-linearly as temperature increases. Conversely, a proportional-to-absolute-temperature (PTAT) voltage increases nearly linearly with respect to temperature. These properties of the base-emitter voltage of a BJT may be leveraged to generate a reference voltage that is PVT invariant. By combining the base-emitter voltage of a BJT with another PTAT voltage, a PVT invariant reference voltage may be generated.

Applicant has identified many technical challenges and difficulties associated with generating a PVT invariant reference voltage. Through applied effort, ingenuity, and innovation, Applicant has solved problems related to generating a PVT reference voltage by developing solutions embodied in the present disclosure, which are described in detail below.

### BRIEF SUMMARY

Various embodiments are directed to an example circuit and method for generating a PVT invariant reference voltage. The example circuit may comprise a reference bipolar junction transistor (BJT) comprising a base terminal, an emitter terminal, and a collector terminal, wherein a ratio of a collector current at the collector terminal and a base current at the base terminal is equal to a beta value. The example circuit may further comprise a resistive element having a first terminal and a second terminal, the second terminal electrically coupled to the emitter terminal of the reference BJT. The example circuit may further comprise a beta-compensated current generation circuit configured to generate a beta-compensated current, based on a proportional to absolute temperature (PTAT) current, at the emitter terminal of the reference BJT, wherein the beta-compensated current is inversely proportional to the beta value. A reference voltage is generated by the example circuit based on a voltage difference between the first terminal of the resistive element and the base of the reference BJT.

In some embodiments, the beta-compensated current generation circuit further comprises an input terminal configured to receive the PTAT current, and an output terminal configured to supply the beta-compensated current, wherein the beta-compensated current is proportional to absolute temperature.

In some embodiments, the PTAT current is received at the first terminal of the resistive element.

In some embodiments, the reference voltage comprises a resistive voltage equivalent to a resistor voltage drop across the resistive element based on a resistive current and a base-emitter voltage equivalent to a base-emitter voltage drop from the emitter terminal to the base terminal of the reference BJT based on an emitter current.

In some embodiments, the resistive current is equivalent to the PTAT current.

In some embodiments, the emitter current is equivalent to the PTAT current plus the beta-compensated current.

In some embodiments, the beta-compensated current generation circuit comprises an operational amplifier comprising a negative input terminal, a positive input terminal, and an output terminal; a first p-type metal-oxide-semiconductor field-effect transistor (PMOS) comprising: a drain terminal electrically coupled to the positive input terminal of the operational amplifier; a gate terminal electrically coupled to the output terminal of the operational amplifier; and a source terminal electrically coupled to a voltage supply. The beta-compensated current generation circuit further comprises a second PMOS comprising: a drain terminal electrically coupled to the negative input terminal of the operational amplifier; a gate terminal electrically coupled to the output terminal of the operational amplifier and the gate terminal of the first PMOS; and a source terminal electrically coupled to the source terminal of the first PMOS and the voltage supply. The beta-compensated current generation circuit further comprises a third PMOS comprising: a source terminal electrically coupled to the source terminal of the first PMOS, the source terminal of the second PMOS, and the voltage supply; a gate terminal electrically coupled to the gate terminal of the first PMOS, and the gate terminal of the second PMOS; and a drain terminal configured to output the beta-compensated current. The beta-compensated current generation circuit further comprises a first BJT in a diode configuration comprising: an emitter terminal configured to receive the proportional to absolute temperature current; a base terminal electrically coupled to an electrical ground reference; and a collector terminal electrically coupled to the base terminal and to the electrical ground reference. The beta-compensated current generation circuit further comprises a first resistor exhibiting a resistive value and comprising: a first terminal electrically coupled to the emitter terminal of the first BJT and configured to receive the proportional to absolute temperature current; and a second terminal electrically coupled to the drain terminal of the first PMOS and the positive input terminal of the operational amplifier. The beta-compensated current generation circuit further comprises a second BJT in a diode configuration comprising: an emitter terminal electrically coupled to the negative input terminal of the operational amplifier, the source terminal of the second PMOS, and configured to receive the proportional to absolute temperature current; a base terminal; and a collector terminal electrically coupled to the electrical ground reference. The beta-compensated current generation circuit further comprises a second resistor exhibiting the resistive value and comprising: a first terminal electrically coupled to the base terminal of the second BJT; and a second terminal electrically coupled to the electrical ground reference and the collector terminal of the second BJT.

In some embodiments, the first BJT and the second BJT exhibit the beta value.

in some embodiments, the resistive element is a variable resistor.

In some embodiments, the reference BJT is a PNP type BJT.

In some embodiments, the reference BJT is manufactured using a complementary metal-oxide-semiconductor (CMOS) process, such that a collector current at the collector terminal of the reference BJT is inaccessible and the beta value of the reference BJT is less than one.

In some embodiments, the reference BJT is configured in a diode configuration, wherein the collector terminal and the base terminal are electrically coupled.

A circuit configured to generate a process, voltage, and temperature invariant reference voltage is further provided. In some embodiments, the circuit comprises a proportional to absolute temperature (PTAT) current source configured to generate a PTAT current that is proportional to absolute temperature, the PTAT current source comprising: a first terminal electrically coupled to an electrical ground reference; and a second terminal. The circuit further comprising a first PTAT p-type metal-oxide-semiconductor field-effect transistor (PMOS) comprising: a source terminal electrically coupled to a voltage supply; a gate terminal; and a drain terminal electrically coupled to the gate terminal and the second terminal of the PTAT current source. The circuit further comprising a second PTAT PMOS comprising: a source terminal electrically coupled to the source terminal of the first PTAT PMOS and the voltage supply; a gate terminal electrically coupled to the gate terminal of the first PTAT PMOS; and a drain terminal. The circuit further comprising a third PTAT PMOS comprising a source terminal electrically coupled to the source terminal of the first PTAT PMOS, the source terminal of the second PTAT PMOS, and the voltage supply; a gate terminal electrically coupled to the gate terminal of the first PTAT PMOS and the gate terminal of the second PTAT PMOS; and a drain terminal. The circuit further comprising a fourth PTAT PMOS comprising: a source terminal electrically coupled to the source terminal of the first PTAT PMOS, the source terminal of the second PTAT PMOS, the source terminal of the third PTAT PMOS, and the voltage supply; a gate terminal electrically coupled to the gate terminal of the first PTAT PMOS, the gate terminal of the second PTAT PMOS, and the gate terminal of the third PTAT PMOS; and a drain terminal The circuit further comprising a beta-compensated current generation circuit. The beta-compensated current generation circuit comprising: a first PTAT input electrically coupled to the drain terminal of the second PTAT PMOS and configured to receive the PTAT current; a second PTAT input electrically coupled to the drain terminal of the third PTAT PMOS and configured to receive the PTAT current; and a beta-compensated current output configured to generate a beta-compensated current, wherein the beta-compensated current is inversely proportional to a beta value. The circuit further comprising a reference bipolar junction transistor (BJT) in a diode configuration comprising: a base terminal electrically coupled to the electrical ground reference; an emitter terminal electrically coupled to the beta-compensated current output of the beta-compensated current generation circuit and configured to receive the beta-compensated current; and a collector terminal electrically coupled to the base terminal and the electrical ground reference; wherein a ratio of a collector current at the collector terminal and a base current at the base terminal is equal to the beta value. The circuit further comprising a reference resistor comprising: a first terminal electrically coupled to the drain terminal of the fourth PTAT PMOS and configured to receive the PTAT current; a second terminal electrically coupled to the beta-compensated current output of the beta-compensated current generation circuit and the emitter terminal of the reference BJT. The reference voltage comprising a voltage difference at the first terminal of the reference resistor and the base terminal of the reference BJT.

In some embodiments, the beta-compensated current generation circuit comprises: an operational amplifier comprising a negative input terminal, a positive input terminal, and an output terminal. The beta-compensated current generation circuit further comprises a first p-type metal-oxide-semiconductor field-effect transistor (PMOS) comprising: a drain terminal electrically coupled to the positive input terminal of the operational amplifier; a gate terminal electrically coupled to the output terminal of the operational amplifier; and a source terminal electrically coupled to the voltage supply. The beta-compensated current generation circuit further comprises a second PMOS comprising: a drain terminal electrically coupled to the negative input terminal of the operational amplifier; a gate terminal electrically coupled to the output terminal of the operational amplifier and the gate terminal of the first PMOS; and a source terminal electrically coupled to the source terminal of the first PMOS and the voltage supply. The beta-compensated current generation circuit further comprises a third PMOS comprising: a source terminal electrically coupled to the source terminal of the second PMOS, the source terminal of the first PMOS, and the voltage supply; a gate terminal electrically coupled to the output terminal of the operational amplifier, the gate terminal of the first PMOS, and the gate terminal of the second PMOS; and a drain terminal configured to output the beta-compensated current. The beta-compensated current generation circuit further comprises a first BJT in a diode configuration comprising: an emitter terminal configured to receive the PTAT current; a base terminal electrically coupled to the electrical ground reference; and a collector terminal electrically couple to the base terminal and to the electrical ground reference. The beta-compensated current generation circuit further comprises a first resistor exhibiting a resistive value and comprising: a first terminal electrically coupled to the emitter terminal of the first BJT and configured to receive the PTAT current; and a second terminal electrically coupled to the drain terminal of the first PMOS and the positive input terminal of the operational amplifier. The beta-compensated current generation circuit further comprises a second BJT in a diode configuration comprising: an emitter terminal electrically coupled to the negative input terminal of the operational amplifier, the drain terminal of the second PMOS, and configured to receive the PTAT current; a base terminal; and a collector terminal electrically coupled to the electrical ground reference. The beta-compensated current generation circuit further comprises a second resistor exhibiting the resistive value and comprising: a first terminal electrically coupled to the base terminal of the second BJT; and a second terminal electrically coupled to the electrical ground reference and the collector terminal of the second BJT.

In some embodiments, the first BJT and the second BJT exhibit the beta value.

In some embodiments, the reference BJT, the first BJT, and the second BJT are PNP type BJTs.

In some embodiments, the reference BJT, the first BJT, and the second BJT are manufactured using a complementary metal-oxide-semiconductor (CMOS) process.

In some embodiments, the reference resistor is a variable resistor.

A method for generating a process, voltage, and temperature invariant reference voltage is further provided. In some embodiments, the method comprises: generating a beta-compensated current based on a proportional to absolute temperature (PTAT) current, wherein the beta-compensated current is inversely proportional to a beta value of a reference bipolar junction transistor (BJT). The method further comprising receiving at an emitter terminal of the reference BJT the beta-compensated current: wherein the reference BJT comprises a base terminal, the emitter terminal, and a collector terminal, and wherein a ratio of a collector current at the collector terminal and a base current at the base terminal is equal to the beta value. The method further comprising receiving the PTAT current at a first terminal of a reference resistive element, the reference resistive element comprising: the first terminal; and a second terminal electrically coupled to the emitter terminal of the reference BJT. The reference voltage is generated based on a voltage difference between the first terminal of the reference resistive element and the base terminal of the reference BJT.

In some embodiments, the reference resistive element is a variable resistor.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates a standard PNP bipolar junction transistor (BJT) in accordance with an example embodiment of the present disclosure.

FIG. 2 depicts an example graph illustrating the PTAT and CTAT components of a PVT invariant reference voltage in accordance with an example embodiment of the present disclosure.

FIG. 3 depicts an example graph illustrating an example variation in PTAT and CTAT properties of a BJT in accordance with an example embodiment of the present disclosure.

FIG. 4 depicts an example graph illustrating a non-linear variation in the CTAT properties of a BJT in accordance with an example embodiment of the present disclosure.

FIG. 5A-FIG. 5B illustrate an example error resulting from non-linear variations in a reference voltage in accordance with an example embodiment of the present disclosure.

FIG. 6 depicts an example beta-compensated current generation circuit in a reference voltage generating circuit in accordance with an example embodiment of the present disclosure.

FIG. 7 depicts an example embodiment of a beta-compensated current generation circuit in accordance with an example embodiment of the present disclosure.

FIG. 8 depicts an example embodiment of a reference voltage generating circuit including a beta-compensated current generation circuit in accordance with an example embodiment of the present disclosure.

FIG. 9 illustrates an example flow diagram of a method for generating a PVT invariant reference voltage in accordance with an example embodiment of the present disclosure.

### DETAILED DESCRIPTION

Example embodiments will be described more fully hereinafter with reference to the accompanying drawings, in which some, but not all embodiments of the inventions of the disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

### Overview

Various example embodiments address technical problems associated with generating a PVT invariant reference voltage. As will be shown herein, there are numerous example scenarios in which a PVT invariant reference voltage may be desired.

Bipolar junction transistors (BJTs) are commonly used to generate reliable, PVT invariant reference voltages. The base-emitter voltage (V_{BE}) extracted from a BJT is complementary-to-absolute-temperature (CTAT). As a CTAT voltage, the base-emitter voltage decreases near-linearly as the temperature increases. A proportional-to-absolute-temperature (PTAT) voltage is a voltage that increases nearly linearly with respect to temperature. Thus, by combining the base-emitter voltage of a BJT with a specially configured PTAT voltage, the CTAT properties of the base-emitter voltage of a BJT may be negated, resulting in a reference voltage that is consistent across various processes, voltages, and temperatures.

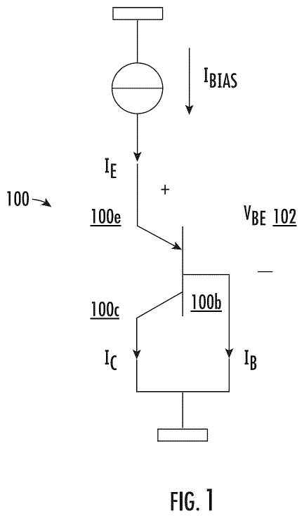

Referring now to FIG. 1, an example PNP BJT 100 is provided. A PNP BJT 100 is manufactured to include three layers of doped semiconductor, a thin n-type semiconductor region placed between two p-type semiconductor regions. As depicted in FIG. 1, the PNP BJT 100 includes three terminals an emitter terminal 100e corresponding with a p-type semiconductor region, a collector terminal 100c corresponding with a second p-type semiconductor region, and a base terminal 100b corresponding with the n-type semiconductor region. In general, a PNP BJT 100 is used to control a large current flow from the emitter terminal 100e (I_{E}) to the collector terminal 100c (I_{C}) based on a small current supplied at the base terminal 100b (I_{B}).

In a PNP BJT 100, flow of current at the collector terminal is defined by the beta value of the PNP BJT 100. The beta value is defined as the ratio of the current at the collector terminal 100c to the current at the base terminal 100b. The beta value, in general, determines the amount of current directed through the base terminal 100b and the amount of current directed through the collector terminal 100c. The beta value of the PNP BJT 100 determines, at least in part, the base-emitter voltage 102 (V_{BE}) of the PNP BJT 100. The base-emitter voltage 102 is the difference in electric potential between the emitter terminal 100e and the base terminal 100b of the PNP BJT 100. As described herein, a reference voltage may be derived from the PNP BJT 100 based on the base-emitter voltage 102.

The beta value, however, is dependent on temperature and process. Thus, as the operating temperature of the PNP BJT 100 changes, so does the beta value. In addition, the beta value changes based on the process used in the manufacture of the PNP BJT 100.

A PNP BJT 100 comprising two p-type semiconductor regions and one n-type semiconductor region may be formed using complementary metal-oxide-semiconductor (CMOS) technology process. In some embodiments, the collector terminal 100c and associated collector current may not be accessible in a PNP BJT 100 formed using a CMOS technology process. A PNP BJT 100 formed using a CMOS technology process results in a parasitic BJT and may have degraded performance compared to BJTs formed using different technologies. For example, PNP BJTs 100 formed using CMOS technology processes generally have very low beta values. Some PNP BJTs 100 formed using CMOS technology processes may have a beta value less than one.

As depicted in FIG. 1, the PNP BJT 100 is configured in a diode configuration. A diode configuration of a BJT occurs in an instance in which the base terminal 100b and the collector terminal 100c of the PNP BJT 100 are electrically coupled. A PNP BJT 100 in a diode configuration is always in an active mode.

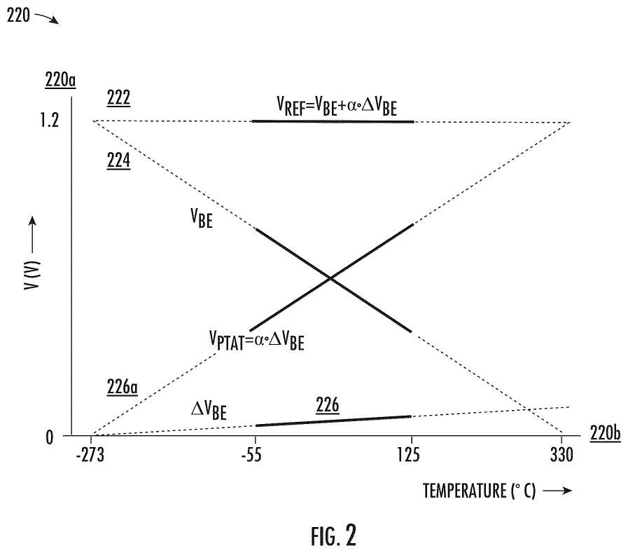

Referring now to FIG. 2, graph 220 plotting voltage 220a with respect to temperature 220b is depicted. As depicted in FIG. 2, an example reference voltage 222 is based on a CTAT base-emitter voltage component 224 (V_{BE}) and a PTAT voltage component 226a derived from a difference in the base-emitter voltage 226 changing with respect to temperature 220b.

As depicted in the example graph 220 of FIG. 2, a PVT invariant reference voltage 222 (V_{REF}) is generated based on a CTAT base-emitter voltage component 224 and a PTAT voltage component 226a. For example, a PVT invariant reference voltage 222 may be generated based on the equation:

$${V}_{R E F} = {V}_{B E} + α \cdot Δ {V}_{B E}$$

where V_{REF} is the PVT invariant reference voltage 222, V_{BE} is the base-emitter voltage of a BJT (e.g., CTAT base-emitter voltage component 224), c is a scaling factor, and ΔV_{BE} is a linear PTAT change in the base-emitter voltage based on process (e.g., difference in the base-emitter voltage 226).

A PVT invariant reference voltage 222 is any voltage generated by an electrical component (e.g., PNP BJT 100) that remains stable. In other words, the voltage generated is not varying with variations in electrical components due to the semiconductor process technology by which the electrical component was manufactured, variations in voltage supplied to the electrical component, and variations in the temperature of the operating environment in which the electrical component is operating. A PVT invariant reference voltage 222 may be utilized to facilitate stable and predictable operation of an electrical device. A PVT invariant reference voltage 222 may be desired by an electrical device to produce predictable, accurate, and consistent results, particularly for an electrical device operating in a harsh environment, for example, an environment with extreme temperatures, or an electrical device in a varying voltage operation. As one non-limiting example, high-precision temperature sensors may utilize a stable reference voltage across temperatures to generate an accurate temperature reading.

As depicted in FIG. 2, the PVT invariant reference voltage 222 includes a CTAT base-emitter voltage component 224. A CTAT base-emitter voltage component 224 is any voltage derived from an electrical component, such as a BJT, that decreases near linearly as the operating temperature of the electrical component increases. In general, the base-emitter voltage of a BJT comprising doped silicon is a CTAT voltage, wherein the base-emitter voltage decreases at about 2 millivolts per degree Celsius. For example, a base-emitter voltage for an example BJT may be 550 millivolts at room temperature (20° Celsius), 548 millivolts at 21° C., 546 millivolts at 22° C., and so on.

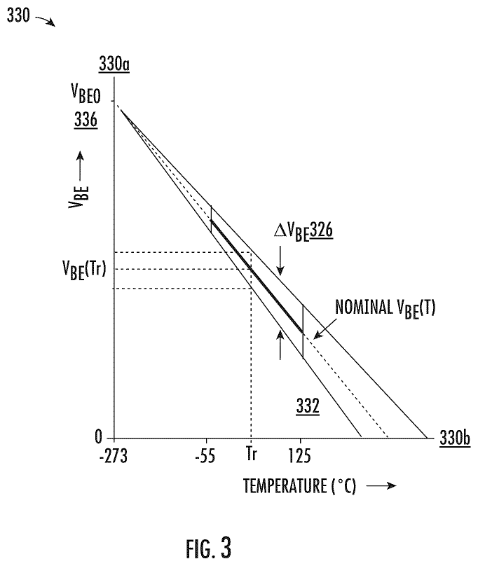

As further depicted in FIG. 2, the PVT invariant reference voltage 222 includes a PTAT voltage component 226a. A PTAT voltage component 226a is any voltage derived from an electrical component, such as a BJT, that increases linearly as the operating temperature of the electrical component increases. In some embodiments, a PTAT voltage component 226a may be derived based on a change in base-emitter voltage of a BJT with respect to temperature, for example, as shown in FIG. 3.

Referring now to FIG. 3, an example graph 330 depicting a variation in base-emitter voltage 330a with respect to temperature 330b of BJTs fabricated with process variation (e.g., base-emitter voltage range 332) is depicted.

As depicted in FIG. 3, the base-emitter voltage 330a of a BJT varies based on process and temperature 330b. The base-emitter voltage range 332 depicted in FIG. 3 represents an example range of base-emitter voltages 330a with respect to temperature 330b across BJTs due to variation in the manufacturing process. Depending on the manufacturing process of a BJT, the base-emitter voltage exhibited by a BJT may respond differently to changes in temperature. For example, the base-emitter voltage of a first BJT manufactured according to a first process and a second BJT manufactured according to a second process will converge on a common base-emitter voltage 336 (V_{BE0}) at absolute zero temperature (−273° C.). However, the first BJT manufactured according to a first process may exhibit a decrease in base-emitter voltage at a rate of 2.1 millivolts per degree Celsius, while the second BJT manufactured according to a second process may exhibit a decrease in base-emitter voltage at a rate of 1.9 millivolts per degree Celsius. In some embodiments, the base-emitter voltage range 332 may be generated based on providing different bias currents to one or more BJTs. Thus, the difference in base-emitter voltage 326 is 0 at absolute zero temperature and increases near-linearly as the temperature increases, as depicted in FIG. 3. Because the difference in base-emitter voltage 326 increases near-linearly with the increase in temperature, the difference in base-emitter voltage 326 derived from the difference in the base-emitter voltage of two or more BJTs manufactured according to different processes is a proportional-to-absolute temperature, or PTAT, value.

Returning to FIG. 2, the difference in base-emitter voltage 226 may be utilized to counteract the CTAT properties of the base-emitter voltage of a BJT. As described in relation to FIG. 3 and depicted in graph 220 the difference in base-emitter voltage 226 of two BJTs increases with respect to temperature in a near-linear manner. However, the rate of increase of the difference in base-emitter voltage 226 may not match the rate of decrease of the base-emitter voltage component 224. Thus, a scaling factor (a) may be determined and utilized to counteract the CTAT properties of the base-emitter voltage component 224. The scaling factor (a) is any value, term, or other constant multiplied by the difference in base-emitter voltage 226 to produce a PTAT voltage component 226a configured to nullify the CTAT base-emitter voltage component 224 of a BJT configured to generate a reference voltage 222. Thus, the reference voltage 222 may be a near-constant value as the operating temperature of the electrical component varies, as shown in FIG. 2.

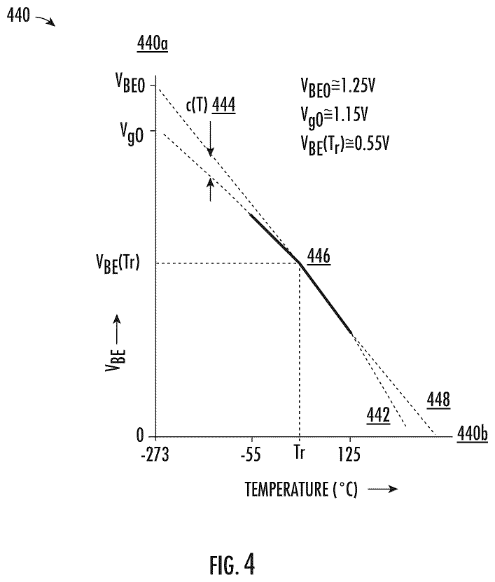

Referring now to FIG. 4, an example graph 440 plotting voltage 440a with respect to temperature 440b is depicted. The example graph 440 illustrates an actual base-emitter voltage 442 of an example BJT compared to a theoretical linear approximation of a base-emitter voltage 448 of an example BJT at reference temperature (Tr).

As depicted in FIG. 4, the CTAT property of the example BJT is not linear in real-life application. The linear approximation of the base-emitter voltage 448 based on the base-emitter voltage at room temperature 446 is depicted. The linear approximation of the base-emitter voltage 448 may be projected onto the y-axis at the initial base-emitter approximation voltage V_{BE0}, while the actual base-emitter voltage 442 converges at the initial base-emitter actual voltage V_{g0}. The difference between the initial base-emitter approximation voltage V_{BE0} and the initial base-emitter actual voltage V_{g0} is due to curvature 444 in the actual base-emitter voltage 442.

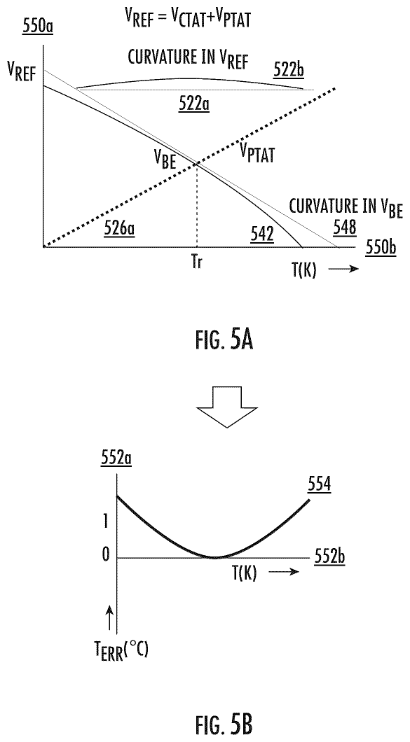

Curvature 444 is any non-linear component of the actual base-emitter voltage 442 in reference to a change in temperature 440b. Curvature 444 in the actual base-emitter voltage 442 will result in variation in the reference voltage with changes in temperature, as shown in FIG. 5A. Curvature 444 results from a number of non-linear components comprising the operation of a BJT. One such non-linear component is the beta value of the BJT. As described herein, the beta value, in general, determines the amount of current directed through the base terminal and the amount of current directed through the collector terminal of a BJT. The equation:

$${I}_{C} = {I}_{E} - {I}_{B} = \frac{{β}_{F}}{1 + {β}_{F}} {I}_{E}$$

where I_{C} is the current at the collector terminal of the BJT, I_{E} is the current at the emitter terminal of the BJT, I_{B} is the current at the base terminal of the BJT, and β_{F} is the current gain of the BJT in a common emitter configuration. Further, the equation for β_{F} may be defined as:

$${β}_{F} ( T ) = {{β}_{F 0} ( \frac{T}{{T}_{r}} )}^{{X}_{T B}}$$

where β_{F} is the current gain of the BJT in a common emitter configuration, β_{F0} is the beta value of the BJT at a reference temperature Tᵣ, T is the temperature, Tᵣ is the reference temperature, and X_{TB} is the temperature dependence on beta. As illustrated in the equation for β_{F}, the beta value of the BJT may have a non-linear impact on the collector current, and thus the base-emitter voltage of the BJT. Compensating for the beta value of the BJT may enable accurate determinations of the base-emitter value across all temperatures, resulting in a generated voltage based on the base-emitter voltage of the BJT that is temperature invariant.

Referring now to FIG. 5A-FIG. 5B, the effect of non-linear components in the base-emitter voltage are depicted. FIG. 5A depicts a graph plotting voltage 550a versus temperature 550b. The graph of FIG. 5A illustrates the effect curvature in the actual base-emitter voltage 542 when compared to the linear approximation of the base-emitter voltage 548 has on the actual reference voltage 522b as compared to the ideal reference voltage 522a, in an instance in which the PTAT voltage component 526a exhibits near linear correspondence with the temperature 550b.

As depicted in FIG. 5A, the actual reference voltage 522b generated based on the actual base-emitter voltage 542 contains a non-linear curvature. As describe herein, the curvature of the actual reference voltage 522b is due, at least in part, to the non-linear variation with temperature of the beta value for the BJT used to generate the actual reference voltage 522b.

A variation in the actual reference voltage 522b compared to the ideal reference voltage 522a may impact the reliability and accuracy of any electronic device utilizing the reference voltage. In a non-limiting example, high-precision temperature sensors may utilize the reference voltage (e.g., actual reference voltage 522b) to determine the temperature of an operating environment. A high-precision temperature may be used, for example, to determine the temperature on or near computer equipment and adjust processing based on the temperature of the compute components (e.g., CPU). In such an embodiment, variation by a few millivolts may change the determined temperature by ±1° Celsius. Thus, to realize a high precision temperature sensor with an accuracy within ±1° Celsius the reference voltage may need to remain within 3 millivolts of the reference voltage, even in extreme temperatures.

Referring now to FIG. 5B, an example error 554 of a measured temperature in degrees Celsius 552a relative to the temperature 552b of the BJT generating the reference voltage is depicted. As depicted in FIG. 5B, the error 554 increases based on the error of the actual reference voltage 522b due to the curvature of the actual base-emitter voltage 542 of the BJT. Thus, as the non-linear curvature of the actual base-emitter voltage 542 diverges from the linear approximation of the base-emitter voltage 548, the error 554 in the temperature readout of the high-precision temperature sensor increases. As depicted in FIG. 5b, at the points of greatest divergence between the actual base-emitter voltage 542 and the linear approximation of the base-emitter voltage 548, the error 554 is greater than 1° Celsius.

As described in FIG. 1-FIG. 5B, non-linear variation in the base-emitter voltage of a BJT based on temperature may result in reference voltages derived from the BJT which vary based on temperature. The non-linear temperature variation may result, at least in part from non-linear variations in the beta value of the BJT based on temperature. As described herein, a reference voltage generated based on the base-emitter voltage of a BJT may be dependent on the value:

$$\frac{β}{1 + β}$$

where β is the beta value of the BJT, representing the current gain of the BJT in a common emitter configuration. For large beta values, the expression

$$\frac{β}{β + 1}$$

converges to 1. Thus, for large beta values, the non-linear components of a reference voltage due to the beta value of the BJT are negligible. However, BJTs manufactured using CMOS technologies often have a low beta value. As the beta value decreases, the non-linear components of the reference voltage become more problematic. In some instances, in which the beta value of the BJT is below 1, the error due to the non-linear components of the beta value of the BJT may become significant.

Various previous examples have attempted to negate reference voltage errors due to low beta values in various ways. In some examples, various techniques are utilized to boost, or increase the beta value of a BJT used to generate a reference voltage. By boosting the beta value of a BJT, the expression

$$\frac{β}{β + 1}$$

begins to converge to 1. However, the beta boosting techniques essential multiply, or square, the beta value of the BJT. Thus, beta boosting techniques may work for beta values greater than 1, however, when the beta value is less than 1, which is often the case with CMOS technologies, multiplying, or squaring, the beta value actually makes the beta value even smaller. Further, exacerbating the error in the reference voltage due to the beta value.

The various example embodiments described herein utilize various techniques to negate the effect of the beta value of a BJT used to generate a reference voltage by supplying a beta-compensated PTAT current to the BJT generating the CTAT base-emitter voltage component of the reference voltage while supplying a pure PTAT current to the resistive element generating the PTAT voltage component of the reference voltage. By providing a beta-compensated PTAT current to the BJT, the CTAT base-emitter voltage component of the reference voltage compensates for any non-linear characteristics of the CTAT base-emitter voltage component due to the beta value of the BJT.

As a result of the herein described example embodiments and in some examples, the stability and reliability of a reference voltage generated based on the base-emitter voltage of a PNP BJT may be greatly improved. In addition, the example embodiments described herein enable the manufacture of PNP BJTs for purposes of reference voltage generation utilizing CMOS techniques. Further, with the improved accuracy of the reference voltage generation, the number of bits required to obtain a precise value may be reduced, reducing the overall area occupied by the reference voltage circuitry.

### Example Circuit

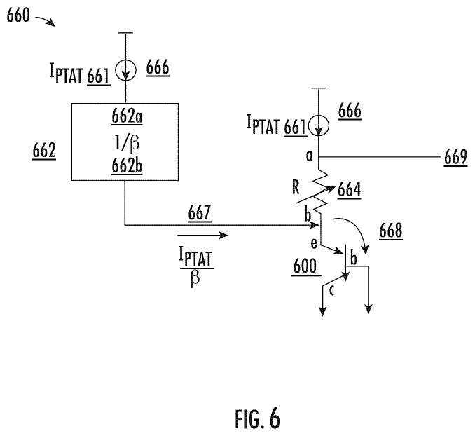

Referring now to FIG. 6, an example reference voltage circuit 660 is provided. As depicted in FIG. 6, the example reference voltage circuit 660 includes a reference resistor 664 electrically coupled to a PTAT current source 666 at a first terminal 664a and an emitter terminal 600e of a reference BJT 600 at a second terminal 664b, the reference BJT 600 further comprising a base terminal 600b and a collector terminal 600c. The emitter terminal 600e of the reference BJT 600 is further electrically coupled to the output terminal 662b of a beta-compensated current generation circuit 662 and configured to receive a beta-compensated current 667. The beta-compensated current generation circuit 662 includes an input terminal 662a configured to receive a PTAT current 661 from the PTAT current source 666. A reference voltage 669 is generated based on the voltage difference between the first terminal 664a of the reference resistor 664 and the base terminal 600b of the reference BJT 600. The reference voltage 669 includes a PTAT voltage component corresponding to a voltage drop at the reference resistor 664 and a beta-compensated, CTAT voltage component corresponding to a base-emitter voltage at the reference BJT 600.

A reference voltage circuit 660 is any circuitry including hardware and/or software configured to generate a reference voltage (e.g., reference voltage 669). A reference voltage 669 is any potential difference supplied to one or more electrical devices as a stable and consistent source of voltage. In some embodiments, a reference voltage 669 is PVT invariant. A PVT invariant reference voltage 669 remains stable with variation in the semiconductor process technology by which the reference voltage circuit 660 was manufactured, variations in voltage supplied to the electrical component, and variations in the temperature of the operating environment in which the reference voltage circuit 660 is operating. A PVT invariant reference voltage 669 may be utilized to facilitate stable and predictable operation of an electrical device. In some embodiments, to generate a reference voltage 669 invariant to temperature, a PTAT voltage component and a CTAT voltage component are combined. The PTAT properties of the PTAT voltage component nullify the CTAT properties of the CTAT voltage component, thus, the resulting reference voltage 669 may be invariant to changes in temperature.

As depicted in FIG. 6, the example reference voltage circuit 660 includes a PTAT current source 666. A PTAT current source 666 refers to one or more current sources configured to generate a PTAT current 661. A PTAT current 661 is a current that increases nearly linearly with an increase in temperature. A PTAT current 661 may be utilized to generate a PTAT voltage. A PTAT voltage is a voltage that increases linearly with an increase in temperature. A PTAT voltage may be generated by supplying a PTAT current 661 to a resistive element, such as reference resistor 664.

A PTAT current source 666 may leverage properties of a BJT to generate a PTAT current 661. For example, as described in relation to FIG. 3, the difference in base-emitter voltages between two or more BJTs manufactured having process variation may increase linearly with an increase in temperature. Similarly, the difference in base-emitter voltages between two or more BJTs supplied with different bias currents may increase linearly with an increase in temperature. Such properties may be leveraged by a PTAT current source 666 to generate a PTAT current 661.

As further depicted in FIG. 6, the example reference voltage circuit 660 includes a reference resistor 664 (e.g., resistive element). A reference resistor 664 refers to one or more electrical components that creates resistance in the flow of electric current according to a resistance value. A voltage drop (e.g., resistive voltage) occurs across a reference resistor 664 based on the current (e.g., resistive current) passing through the resistor according to Ohm's law. Thus, the resistive voltage across the reference resistor 664 is equal to the resistive current times the resistive value of the reference resistor 664. In some embodiments, the reference resistor 664 may comprise a variable resistor. A variable resistor is a resistive element for which the resistive value of the resistive element may be adjusted. The resistive value of a variable resistor may be adjusted by electrical signal, mechanical mechanism, and/or a combination thereof. The resistive voltage is similarly adjusted based on the resistance value of the variable resistor. In an instance in which the reference resistor receives a PTAT current, for example, the PTAT current 661 generated by PTAT current source 666, the resistive voltage associated with the voltage drop across the reference resistor 664 is a PTAT voltage.

As further depicted in FIG. 6, the example reference voltage circuit 660 includes a reference BJT 600. As described in relation to FIG. 1, the base-emitter voltage of a BJT 600 may be utilized to generate a reference voltage. The base-emitter voltage of a BJT 600 is a CTAT voltage, meaning the voltage decreases nearly linearly with an increase in temperature. In addition, the difference in base-emitter voltages between two BJTs carrying different current densities, increases linearly with an increase in temperature. Thus, two or more BJTs may be utilized to generate a PTAT voltage.

In addition, a BJT 600 may comprise a beta value. The beta value of a BJT 600 is defined as the ratio of the current at the collector terminal 600c to the current at the base terminal 600b. As further described in relation to FIG. 4, the beta value may experience non-linear variations with respect to temperature. Thus, the base-emitter voltage of a BJT 600 may experience non-linear variations related to the beta value of the BJT 600. As described herein, the reference voltage of a BJT 600 is proportional to

$$\frac{β}{β + 1}$$

where β is the beta value of the BJT 600. Thus, in an instance in which the emitter current from the emitter terminal 600e of the BJT 600 to the base terminal 600b of the BJT 600 is proportional to

$$\frac{β + 1}{β} ,$$

the non-linear variations in the base-emitter voltage due to β may be nullified.

In some embodiments, the BJT 600 may comprise two p-type semiconductor regions and one n-type semiconductor region (PNP) formed using CMOS technology processes freely available and having no technology dependency. In some embodiments, the collector terminal 600c and associated collector current may not be accessible in the PNP-type BJT 600 formed using a CMOS technology process. The PNP-type BJT 600 formed using a CMOS technology process results in a parasitic BJT and may have degraded performance compared to BJTs formed using different technologies. For example, PNP-type BJTs 600 formed using CMOS technology processes generally have very low beta values. Some PNP-type BJTs 600 formed using CMOS technology processes may have a beta value less than one.

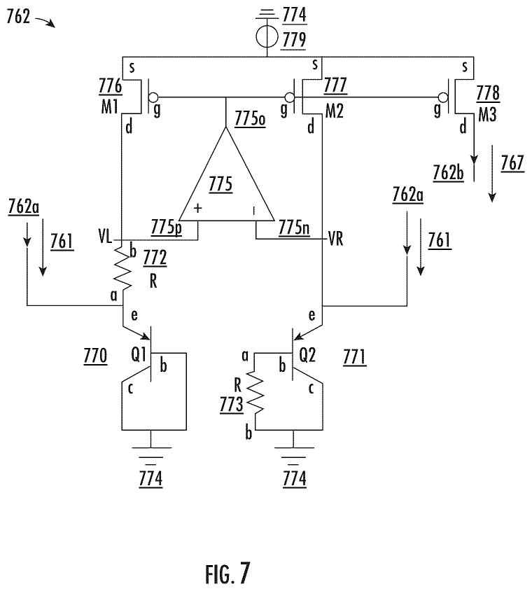

As further depicted in FIG. 6, the example reference voltage circuit 660 includes a beta-compensated current generation circuit 662. The beta-compensated current generation circuit 662 is configured to receive a PTAT current 661 at the input terminal 662a and output a beta-compensated current 667 at an output terminal 662b, that is inversely proportional to the beta value of the reference BJT 600 and based on the PTAT current 661. The beta-compensated current generation circuit 662 may include any combination of electrical components arranged in order to generate a current inversely proportional to the beta value of the reference BJT 600. An example embodiment of a beta-compensated current generation circuit 662 is described in relation to FIG. 7.

As depicted in FIG. 6, the beta-compensated current generation circuit 662 is configured to generate a beta-compensated current 667 based on the PTAT current 661 and inversely proportional to the beta value of the reference BJT 600. The beta-compensated current 667 is generated by the beta-compensated current generation circuit 662 to negate the variations in the base-emitter voltage of the reference BJT 600 due to the beta value variations with changes in temperature. In some embodiments, the beta-compensated current generation circuit 662 is configured to generate a beta-compensated current 667 equivalent to the PTAT current 661 (I_{PTAT}) divided by the beta value (B) of the reference BJT 600. In such an instance, the beta-compensated current 667 received at the emitter terminal 600e of the reference BJT 600 is equal to

$$\frac{{I}_{P T A T}}{β} .$$

Further, the current received at the emitter terminal 600e of the reference BJT 600 from the second terminal 664b of the reference resistor 664 is equal to I_{PTAT}. Thus, the emitter current (I_{E}) is equal to:

$${I}_{E} = {I}_{P T A T} + \frac{{I}_{P T A T}}{β} = {I}_{P T A T} ( \frac{1 + β}{β} )$$

Since the emitter current is proportional to

$$\frac{1 + β}{β} ,$$

the emitter current negates the non-linearities in the reference voltage 669 due to beta and generates a reference voltage 669 invariant to changes in temperature.

### Example Beta-Compensated Current Generation Circuit Embodiments

Referring now to FIG. 7, an example embodiment of a beta-compensated current generation circuit 762 is provided. As depicted in FIG. 7, the example beta-compensated current generation circuit 762 includes an operational amplifier 775 comprising a negative input terminal 775n, a positive input terminal 775p, and an output terminal 7750. The example beta-compensated current generation circuit 762 further includes a first p-type metal-oxide-semiconductor field-effect transistor (PMOS) 776 comprising a drain terminal 776d electrically coupled to the positive input terminal 775p of the operational amplifier 775, a gate terminal 776g electrically coupled to the output terminal 7750 of the operational amplifier 775, and a source terminal 776s electrically coupled to a voltage supply 779. The example beta-compensated current generation circuit 762 further includes a second PMOS 777 comprising a drain terminal 777d electrically coupled to the negative input terminal 775n of the operational amplifier 775, a gate terminal 777g electrically coupled to the output terminal 7750 of the operational amplifier 775 and the gate terminal 776g of the first PMOS 776, and a source terminal 777s electrically coupled to the source terminal 776s of the first PMOS 776 and the voltage supply 779. The beta-compensated current generation circuit 762 further includes a third PMOS 778 including a source terminal 778s electrically coupled to the source terminal 777s of the second PMOS 777, the source terminal 776s of the first PMOS 776, and the voltage supply 779; a gate terminal 778g electrically coupled to the gate terminal 777g of the second PMOS 777, and the gate terminal 776g of the first PMOS 776. The beta-compensated current generation circuit 762 further includes a first BJT 770 in a diode configuration, including an emitter terminal 770e configured to receive a proportional to absolute temperature (PTAT) current from the input terminal 762a, a base terminal 770b electrically coupled to an electrical ground reference 774, and a collector terminal 770c electrically coupled to the base terminal 770b and to the electrical ground reference 774. The beta-compensated current generation circuit 762 further includes a first resistor 772 exhibiting a resistive value (R) and comprising a first terminal 772a electrically coupled to the emitter terminal 770e of the first BJT 770 and configured to receive the PTAT current 761, and a second terminal 772b electrically coupled to the drain terminal 776d of the first PMOS 776 and the positive input terminal 775p of the operational amplifier 775. The beta-compensated current generation circuit 762 further includes a second BJT 771 in a diode configuration comprising an emitter terminal 771e electrically coupled to the negative input terminal 775n of the operational amplifier 775, the drain terminal 777d of the second PMOS 777, and configured to receive the PTAT current 761 from the input terminal 762a; a base terminal 771b; and a collector terminal 771c electrically coupled to the electrical ground reference 774. The beta-compensated current generation circuit 762 further including a second resistor 773 exhibiting the resistive value and comprising a first terminal 773a electrically coupled to the base terminal 771b of the second BJT 771, and a second terminal 773b electrically coupled to the electrical ground reference 774 and the collector terminal 771c of the second BJT 771. The voltage supply 779 is further electrically coupled to the electrical ground reference 774.

As depicted in FIG. 7, the example beta-compensated current generation circuit 762 includes two BJTs (e.g., first BJT 770, second BJT 771). A BJT refers to any combination of electrical components that controls the flow of current through two terminals (e.g., emitter terminal, collector terminal) based on the amount of current that flows through a third terminal (e.g., base terminal).

In a BJT, flow of current at the collector terminal is defined by a beta value of the BJT. The beta value is the ratio of the current at the collector terminal to the current at the base terminal. The beta value of the first BJT 770 and the second BJT 771 of the example beta-compensated current generation circuit 762, are equivalent to each other, and equivalent to the reference BJT (e.g., reference BJT 600 as described in relation to FIG. 6). Since the beta value of a BJT is process dependent, the first BJT 770, the second BJT 771, and the reference BJT are manufactured according to the same process.

As depicted in FIG. 7, the BJTs are PNP-type BJTs. A BJT is manufactured to include three layers of doped semiconductor. A PNP-type BJT includes a thin n-type semiconductor region placed between two p-type semiconductor regions. The two p-type semiconductor regions and one n-type semiconductor region are formed using complementary metal-oxide-semiconductor (CMOS) technology process. Using a CMOS technology process, the collector terminal and associated collector current may not be accessible in a PNP-type BJT. As depicted in FIG. 7, the BJTs are configured in a diode configuration. A diode configuration of a BJT occurs in an instance in which the base terminal and the collector terminal of the BJT are electrically coupled. A BJT in a diode configuration is always in an active mode.

As further depicted in FIG. 7, the example beta-compensated current generation circuit 762 includes a plurality of resistive elements (e.g., first resistor 772, second resistor 773). A resistive element refers to one or more electrical components configured to resist the flow of electric current. Although depicted as standard resistors in FIG. 7, the resistive elements may comprise any electrical component configured to resist the flow of electric current and induce a voltage drop across the terminals, for example a variable resistor. As depicted in FIG. 7, the resistive value of the first resistor 772 and the second resistor 773 are equivalent.

As further depicted in FIG. 7, the example beta-compensated current generation circuit 762 includes an operational amplifier (e.g., operational amplifier 775). An operational amplifier refers to one or more electrical components configured to amplify the voltage between two input terminals, for example, a positive input terminal and a negative input terminal, and output the result on an output terminal.

As further depicted in FIG. 7, the example beta-compensated current generation circuit 762 includes a plurality of PMOS transistors (e.g., first PMOS 776, second PMOS, 777, third PMOS 778). An PMOS transistor refers to one or more semiconductor devices configured to control the flow of electric current through the rectifying transistor component by applying or removing a voltage. In general, an PMOS transistor includes three terminals, a source terminal, a gate terminal, and a drain terminal. The source terminal is the terminal at which, when enabled, current generally flows into the PMOS transistor. The drain terminal is the point at which the current generally flows out of the PMOS transistor. The gate terminal of an PMOS transistor is used to control the flow of current between the source terminal and the drain terminal. As depicted in FIG. 7, the PMOS transistors are p-type transistors. A p-type transistor is configured to transmit a current when a voltage applied to the gate of the transistor is below a certain threshold voltage, generally negative.

Although depicted as a p-type metal-oxide-semiconductor field-effect transistor (MOSFET), the PMOS transistor may comprise any transistor component configured to control the flow of electricity by applying a voltage at the gate terminal. For example, the beta-compensated current generation circuit 762 may be reconfigured to enable the use of n-type transistors. An n-type transistor is configured to transmit a current when the voltage applied to the gate of the transistor is above a certain threshold voltage, generally positive.

The configuration of electronic components depicted in FIG. 7, ensure a beta-compensated current 767 is output on the output terminal 762b of the beta-compensated current generation circuit 762 based on the PTAT current 761 provided at the input terminal 762a of the beta-compensated current generation circuit 762.

In the depicted embodiment, the operational amplifier 775 ensures the voltages VL and VR are equivalent.

VL=VR

VL is the sum of the voltage drop across the first resistor 772 and the base-emitter voltage (V_{BE1}) of the first BJT 770. VR is equivalent to the base-emitter voltage (V_{BE2}) of the second BJT 771 and the voltage drop across the second resistor 773. Thus, VL=VR may be represented by the equation:

$${I}_{B E T A} \times R + {V}_{B E 1} = \frac{{I}_{B E T A} + {I}_{P T A T}}{β + 1} \times R + {V}_{B E 2}$$

where I_{BETA} is the beta-compensated current 767 at the output terminal 762b of the beta-compensated current generation circuit 762; R is the resistance value of the first resistor 772 and the second resistor 773; I_{PTAT} is the PTAT current 761 at the input terminal 762a of the beta-compensated current generation circuit 762; and β is the beta value of the first BJT 770 and the second BJT 771.

Since the current passing through the first BJT 770 and the second BJT 771 is equivalent, and the first BJT 770 and the second BJT 771 are equivalent in size, base-emitter voltage (V_{BE1}) of the first BJT 770 and the base-emitter voltage (V_{BE2}) of the second BJT 771 are equal. In addition, the resistance value R of the first resistor 772 and the second resistor 773 are equal. Thus, the values V_{BE1} and V_{BE2} cancel, as well as the Rs, and the equation may be rewritten as:

$${I}_{B E T A} = \frac{{I}_{B E T A} + {I}_{P T A T}}{β + 1}$$

$${I}_{B E T A} - \frac{{I}_{B E T A}}{β + 1} = \frac{{I}_{P T A T}}{β + 1}$$

$${I}_{B E T A} \times ( 1 - \frac{1}{β + 1} ) = \frac{{I}_{P T A T}}{β + 1}$$

$${I}_{B E T A} \times ( \frac{β}{β + 1} ) = \frac{{I}_{P T A T}}{β + 1}$$

$${I}_{B E T A} = \frac{{I}_{P T A T}}{β}$$

Thus, the beta-compensated current 767 generated at the output terminal 762b of the beta-compensated current generation circuit 762 is inversely proportional to the beta value of the reference BJT (e.g., reference BJT 600) utilized to generate the reference voltage.

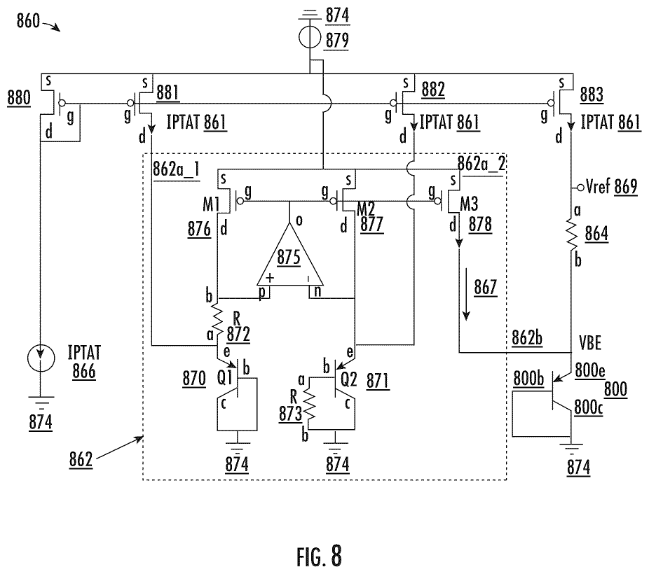

Referring now to FIG. 8, an example embodiment of a reference voltage circuit 860 comprising an example embodiment of a beta-compensated current generation circuit 862, is provided.

As depicted in FIG. 8, the example beta-compensated current generation circuit 862 includes an operational amplifier 875 comprising a negative input terminal 875n, a positive input terminal 875p, and an output terminal 8750. The example beta-compensated current generation circuit 862 further includes a first p-type metal-oxide-semiconductor field-effect transistor (PMOS) 876 comprising a drain terminal 876d electrically coupled to the positive input terminal 875p of the operational amplifier 875, a gate terminal 876g electrically coupled to the output terminal 8750 of the operational amplifier 875, and a source terminal 876s electrically coupled to a voltage supply 879. The example beta-compensated current generation circuit 862 further includes a second PMOS 877 comprising a drain terminal 877d electrically coupled to the negative input terminal 875n of the operational amplifier 875; a gate terminal 877g electrically coupled to the output terminal 8750 of the operational amplifier 875 and the gate terminal 876g of the first PMOS 876; and a source terminal 877s electrically coupled to the source terminal 876s of the first PMOS 876 and to the voltage supply 879. The beta-compensated current generation circuit 862 further includes a third PMOS 878 including a source terminal 878s electrically coupled to the source terminal 877s of the second PMOS 877, the source terminal 876s of the first PMOS 876, and the voltage supply 879; a gate terminal 878g electrically coupled to the gate terminal 877g of the second PMOS 877, and the gate terminal 876g of the first PMOS 876. The beta-compensated current generation circuit 862 further includes a first BJT 870 in a diode configuration, including an emitter terminal 870e configured to receive a proportional to absolute temperature (PTAT) current 861 from the input terminal 862a_1 (e.g., first PTAT input), a base terminal 870b electrically coupled to an electrical ground reference 874, and a collector terminal 870c electrically coupled to the base terminal 870b and to the electrical ground reference 874. The beta-compensated current generation circuit 862 further includes a first resistor 872 exhibiting a resistive value (R) and comprising a first terminal 872a electrically coupled to the emitter terminal 870e of the first BJT 870 and configured to receive the PTAT current 861, and a second terminal 872b electrically coupled to the drain terminal 876d of the first PMOS 876 and the positive input terminal 875p of the operational amplifier 875. The beta-compensated current generation circuit 862 further includes a second BJT 871 in a diode configuration comprising an emitter terminal 871e electrically coupled to the negative input terminal 875n of the operational amplifier 875, the drain terminal 877d of the second PMOS 877, and configured to receive the PTAT current 861 from the input terminal 862a_2 (e.g., second PTAT input); a base terminal 871b; and a collector terminal 871c electrically coupled to the electrical ground reference 874. The beta-compensated current generation circuit 862 further including a second resistor 873 exhibiting the resistive value and comprising a first terminal 873a electrically coupled to the base terminal 871b of the second BJT 871, and a second terminal 873b electrically coupled to the electrical ground reference 874 and the collector terminal 871c of the second BJT 871. The voltage supply 874 is further electrically coupled to the electrical ground reference 874.

As further depicted in FIG. 8, the example reference voltage circuit 860 includes a proportional to absolute temperature (PTAT) current source 866 configured to generate a PTAT current 861 that is proportional to absolute temperature. The PTAT current source 866 includes a first terminal electrically coupled to an electrical ground reference 874, and a second terminal.

The example reference voltage circuit 860 further includes a first PTAT p-type metal-oxide-semiconductor field-effect transistor (PMOS) 880 including a source terminal 880s electrically coupled to the voltage supply 879; a gate terminal 880g; and a drain terminal 880d electrically coupled to the gate terminal 880g and the second terminal of the PTAT current source 866.

The example reference voltage circuit 860 further includes a second PTAT PMOS 881 including a source terminal 881s electrically coupled to the source terminal 880s of the first PTAT PMOS 880 and the voltage supply 879; a gate terminal 881g electrically coupled to the gate terminal 880g of the first PTAT PMOS 880; and a drain terminal 881d electrically coupled to the input terminal 862a_1 of the beta-compensated current generation circuit 862.

The example reference voltage circuit 860 further includes a third PTAT PMOS 882 including a source terminal 882s electrically coupled to the source terminal 880s of the first PTAT PMOS 880, the source terminal 881s of the second PTAT PMOS 881, and the voltage supply 879; a gate terminal 882g electrically coupled to the gate terminal 880g of the first PTAT PMOS 880 and the gate terminal 881g of the second PTAT PMOS 881; and a drain terminal 882d electrically coupled to the input terminal 862a_2 of the beta-compensated current generation circuit 862.

The example reference voltage circuit 860 further includes a fourth PTAT PMOS 883 including, a source terminal 883s electrically coupled to the source terminal 880s of the first PTAT PMOS 880, the source terminal 881s of the second PTAT PMOS 881, the source terminal 882s of the third PTAT PMOS 882, and the voltage supply 879; a gate terminal 883g electrically coupled to the gate terminal 880g of the first PTAT PMOS 880, the gate terminal 881g of the second PTAT PMOS 881, and the gate terminal 882g of the third PTAT PMOS 882; and a drain terminal 883d.

The example reference voltage circuit 860 further includes a reference bipolar junction transistor (BJT) 864 in a diode configuration. The reference BJT 800 includes a base terminal 800b electrically coupled to the electrical ground reference 874; an emitter terminal 800e electrically coupled to the output terminal 862b (e.g., beta-compensated current output) of the beta-compensated current generation circuit 862 and configured to receive the beta-compensated current 867; and a collector terminal 800c electrically coupled to the base terminal 800b and the electrical ground reference 874.

The example reference voltage circuit 860 further includes a reference resistor 864 including a first terminal 864a electrically coupled to the drain terminal 883d of the fourth PTAT PMOS 883 and configured to receive the PTAT current 861; a second terminal 864b electrically coupled to the output terminal 862b (e.g., beta-compensated current output) of the beta-compensated current generation circuit 862 and the emitter terminal 800e of the reference BJT 800.

As depicted in FIG. 8, the example reference voltage circuit 860 is configured to generate a reference voltage 869 based on the difference in electric potential between the first terminal 864a of the reference resistor 864 and the base terminal 800b of the reference BJT 800. As depicted in FIG. 8, the reference voltage 869 generated by the reference voltage circuit 860 includes a PTAT voltage component and a CTAT voltage component. The PTAT voltage component corresponds to the voltage drop across the reference resistor 864. Because a PTAT current 861 is supplied to the reference resistor 864, the resulting voltage drop across the reference resistor 864 is a PTAT voltage and comprises the PTAT voltage component of the reference voltage 869. As further depicted in FIG. 8, the reference voltage 869 comprises a CTAT component corresponding to the voltage drop from the emitter terminal 800e to the base terminal 800b of the reference BJT 800.

As described herein, the beta-compensated current 867 (I_{BETA}) is based on the PTAT current 861 (I_{PTAT}) and inversely proportional to the beta value (β) of the reference BJT 800 (e.g.,

$${I}_{B E T A} = \frac{{I}_{P T A T}}{β} ) .$$

Further, the beta-compensated current 867 (I_{BETA}) is combined with the PTAT current 861 (I_{PTAT}) at the emitter terminal 800e of the reference BJT 800. Thus, the current (I_{BE}) transmitted through the reference BJT 800 is equivalent to:

$${I}_{B E} = \frac{{I}_{P T A T}}{β} + {I}_{P T A T} = {I}_{P T A T} ( \frac{1 + β}{β} ) .$$

As described herein,

$$( \frac{1 + β}{β} )$$

is the inverse of the non-linear contributions to the base-emitter voltage generated by the reference BJT 800 due to the beta value of the reference BJT 800. Thus, the current (I_{BE}) transmitted to through the reference BJT 800 negates the non-linear contributions of the beta value to the reference voltage 869. The result is a stable reference voltage 869 and invariant to variations in temperature.

### Example Method

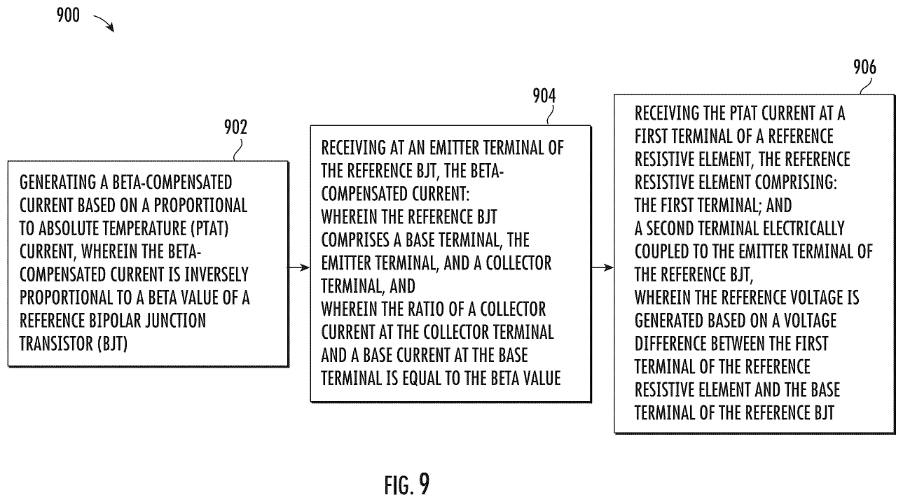

Referring now to FIG. 9, an example process 1000 for generating a PVT invariant reference voltage (e.g., reference voltage 669, 769, 869) with a reference BJT (e.g., reference BJT 600, 700, 800) manufactured as a PNP-type BJT using CMOS technologies is provided. At block 902, the reference voltage circuit (e.g., reference voltage circuit 660, 860) generates a beta-compensated current (e.g., beta-compensated current 667, 767, 867) based on a proportional to absolute temperature (PTAT) current (e.g., PTAT current 661, 761, 861), wherein the beta-compensated current is inversely proportional to a beta value of a reference bipolar junction transistor (BJT). As described herein, the base-emitter voltage of the reference BJT exhibits non-linear irregularities that vary with temperature and are proportional to the beta value of the reference BJT. By transmitting a beta-compensated current to the reference BJT, the non-linear irregularities may be negated.

At block 904, the reference voltage circuit receives at an emitter terminal (e.g., emitter terminal 600e, 800e) of the reference BJT, the beta-compensated current, wherein the reference BJT comprises a base terminal (e.g., base terminal 600b, 800b), the emitter terminal, and a collector terminal (e.g., collector terminal 600c, 800c), and wherein the ratio of a collector current at the collector terminal and a base current at the base terminal is equal to the beta value. As described herein, the beta-compensated current is received at the reference BJT, bypassing the reference resistor accounting for the PTAT voltage component of the reference current.

At block 906, the reference voltage circuit receives the PTAT current at a first terminal of a reference resistive element (e.g., reference resistor 664, 864), the reference resistive element comprising the first terminal (e.g., first terminal 864a), and a second terminal (e.g., second terminal 864b) electrically coupled to the emitter terminal of the reference BJT, wherein the reference voltage is generated based on a voltage difference between the first terminal of the reference resistive element and the base terminal of the reference BJT. As further described herein, the reference voltage is generated based on the voltage across the resistive element. Such voltage is a PTAT voltage due to the PTAT current transmitted across the resistive element. The reference voltage also comprises a CTAT voltage corresponding to the base-emitter voltage of the reference BJT. The base-emitter voltage is generated based on a combination of the PTAT current and the beta-compensated current based on the PTAT current. Thus, the current generating the base-emitter voltage at the reference BJT compensates for non-linear irregularities in the emitter current proportional to the beta value of the reference BJT. Negating the non-linear irregularities produces a reference voltage that is invariant to temperature, resulting in a stable and accurate reference voltage across the temperature spectrum.

While this detailed description has set forth some embodiments of the present invention, the appended claims cover other embodiments of the present invention which differ from the described embodiments according to various modifications and improvements. For example, one skilled in the art may recognize that such principles may be applied to any electronic device that utilizes a reference voltage, particularly a reference voltage generated using a PNP-type BJT developed using CMOS technologies that is deployed in an environment with varying temperatures. For example, high-precision temperature sensors, pressure sensors, audio sensors, optical sensors, other sensing devices, analog-to-digital converters, power supplies, instrumentation, medical equipment, battery management systems, computer electronics, automotive systems, and so on.

Within the appended claims, unless the specific term “means for” or “step for” is used within a given claim, it is not intended that the claim be interpreted under 35 U.S.C. 112, paragraph 6.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. A circuit comprising:
a reference bipolar junction transistor (BJT) comprising a base terminal, an emitter terminal, and a collector terminal,
wherein a ratio of a collector current at the collector terminal and a base current at the base terminal is equal to a beta value;
a resistive element having a first terminal and a second terminal, the second terminal electrically coupled to the emitter terminal of the reference BJT; and
a beta-compensated current generation circuit configured to generate a beta-compensated current, based on a proportional to absolute temperature (PTAT) current, at the emitter terminal of the reference BJT,
wherein the beta-compensated current is inversely proportional to the beta value,
wherein a reference voltage is generated based on a voltage difference between the first terminal of the resistive element and the base of the reference BJT.

2. The circuit of claim 1, the beta-compensated current generation circuit further comprising:
an input terminal configured to receive the PTAT current; and
an output terminal configured to supply the beta-compensated current,
wherein the beta-compensated current is proportional to absolute temperature.

3. The circuit of claim 2, wherein the PTAT current is received at the first terminal of the resistive element.

4. The circuit of claim 3, the reference voltage comprising:
a resistive voltage equivalent to a resistor voltage drop across the resistive element based on a resistive current; and
a base-emitter voltage equivalent to a base-emitter voltage drop from the emitter terminal to the base terminal of the reference BJT based on an emitter current.

5. The circuit of claim 4, wherein the resistive current is equivalent to the PTAT current.

6. The circuit of claim 4, wherein the emitter current is equivalent to the PTAT current plus the beta-compensated current.

7. The circuit of claim 2, wherein the beta-compensated current generation circuit comprises:
an operational amplifier comprising a negative input terminal, a positive input terminal, and an output terminal;
a first p-type metal-oxide-semiconductor field-effect transistor (PMOS) comprising:
a drain terminal electrically coupled to the positive input terminal of the operational amplifier;
a gate terminal electrically coupled to the output terminal of the operational amplifier; and
a source terminal electrically coupled to a voltage supply;
a second PMOS comprising:
a drain terminal electrically coupled to the negative input terminal of the operational amplifier;
a gate terminal electrically coupled to the output terminal of the operational amplifier and the gate terminal of the first PMOS; and
a source terminal electrically coupled to the source terminal of the first PMOS and the voltage supply;
a third PMOS comprising:
a source terminal electrically coupled to the source terminal of the first PMOS, the source terminal of the second PMOS, and the voltage supply;
a gate terminal electrically coupled to the gate terminal of the first PMOS, and the gate terminal of the second PMOS; and
a drain terminal configured to output the beta-compensated current;
a first BJT in a diode configuration comprising:
an emitter terminal configured to receive the proportional to absolute temperature current;
a base terminal electrically coupled to an electrical ground reference; and
a collector terminal electrically coupled to the base terminal and to the electrical ground reference;
a first resistor exhibiting a resistive value and comprising:
a first terminal electrically coupled to the emitter terminal of the first BJT and configured to receive the proportional to absolute temperature current; and
a second terminal electrically coupled to the drain terminal of the first PMOS and the positive input terminal of the operational amplifier;
a second BJT in a diode configuration comprising:
an emitter terminal electrically coupled to the negative input terminal of the operational amplifier, the source terminal of the second PMOS, and configured to receive the proportional to absolute temperature current;
a base terminal; and
a collector terminal electrically coupled to the electrical ground reference;
a second resistor exhibiting the resistive value and comprising:
a first terminal electrically coupled to the base terminal of the second BJT; and
a second terminal electrically coupled to the electrical ground reference and the collector terminal of the second BJT.

8. The circuit of claim 7, wherein the first BJT and the second BJT exhibit the beta value.

9. The circuit of claim 1, wherein the resistive element is a variable resistor.

10. The circuit of claim 1, wherein the reference BJT is a PNP type BJT.

11. The circuit of claim 10, wherein the reference BJT is manufactured using a complementary metal-oxide-semiconductor (CMOS) process, such that a collector current at the collector terminal of the reference BJT is inaccessible and the beta value of the reference BJT is less than one.

12. The circuit of claim 10, wherein the reference BJT is configured in a diode configuration, wherein the collector terminal and the base terminal are electrically coupled.

13. A circuit configured to generate a process, voltage, and temperature invariant reference voltage, the circuit comprising:
a proportional to absolute temperature (PTAT) current source configured to generate a PTAT current that is proportional to absolute temperature, the PTAT current source comprising:
a first terminal electrically coupled to an electrical ground reference; and
a second terminal;
a first PTAT p-type metal-oxide-semiconductor field-effect transistor (PMOS) comprising:
a source terminal electrically coupled to a voltage supply;
a gate terminal; and
a drain terminal electrically coupled to the gate terminal and the second terminal of the PTAT current source;
a second PTAT PMOS comprising:
a source terminal electrically coupled to the source terminal of the first PTAT PMOS and the voltage supply;
a gate terminal electrically coupled to the gate terminal of the first PTAT PMOS; and
a drain terminal;
a third PTAT PMOS comprising:
a source terminal electrically coupled to the source terminal of the first PTAT PMOS, the source terminal of the second PTAT PMOS, and the voltage supply;
a gate terminal electrically coupled to the gate terminal of the first PTAT PMOS and the gate terminal of the second PTAT PMOS; and
a drain terminal;
a fourth PTAT PMOS comprising:
a source terminal electrically coupled to the source terminal of the first PTAT PMOS, the source terminal of the second PTAT PMOS, the source terminal of the third PTAT PMOS, and the voltage supply;
a gate terminal electrically coupled to the gate terminal of the first PTAT PMOS, the gate terminal of the second PTAT PMOS, and the gate terminal of the third PTAT PMOS; and
a drain terminal;
a beta-compensated current generation circuit comprising:
a first PTAT input electrically coupled to the drain terminal of the second PTAT PMOS and configured to receive the PTAT current;
a second PTAT input electrically coupled to the drain terminal of the third PTAT PMOS and configured to receive the PTAT current; and
a beta-compensated current output configured to generate a beta-compensated current, wherein the beta-compensated current is inversely proportional to a beta value;
a reference bipolar junction transistor (BJT) in a diode configuration comprising:
a base terminal electrically coupled to the electrical ground reference;
an emitter terminal electrically coupled to the beta-compensated current output of the beta-compensated current generation circuit and configured to receive the beta-compensated current; and
a collector terminal electrically coupled to the base terminal and the electrical ground reference;
wherein a ratio of a collector current at the collector terminal and a base current at the base terminal is equal to the beta value; and
a reference resistor comprising:
a first terminal electrically coupled to the drain terminal of the fourth PTAT PMOS and configured to receive the PTAT current;
a second terminal electrically coupled to the beta-compensated current output of the beta-compensated current generation circuit and the emitter terminal of the reference BJT,
wherein, the reference voltage comprises a voltage difference at the first terminal of the reference resistor and the base terminal of the reference BJT.

14. The circuit of claim 13, wherein the beta-compensated current generation circuit comprises:
an operational amplifier comprising a negative input terminal, a positive input terminal, and an output terminal;
a first p-type metal-oxide-semiconductor field-effect transistor (PMOS) comprising:
a drain terminal electrically coupled to the positive input terminal of the operational amplifier;
a gate terminal electrically coupled to the output terminal of the operational amplifier; and
a source terminal electrically coupled to the voltage supply;
a second PMOS comprising:
a drain terminal electrically coupled to the negative input terminal of the operational amplifier;
a gate terminal electrically coupled to the output terminal of the operational amplifier and the gate terminal of the first PMOS; and
a source terminal electrically coupled to the source terminal of the first PMOS and the voltage supply;
a third PMOS comprising:
a source terminal electrically coupled to the source terminal of the second PMOS, the source terminal of the first PMOS, and the voltage supply;
a gate terminal electrically coupled to the output terminal of the operational amplifier, the gate terminal of the first PMOS, and the gate terminal of the second PMOS; and
a drain terminal configured to output the beta-compensated current;
a first BJT in a diode configuration comprising:
an emitter terminal configured to receive the PTAT current;
a base terminal electrically coupled to the electrical ground reference; and
a collector terminal electrically couple to the base terminal and to the electrical ground reference;
a first resistor exhibiting a resistive value and comprising:
a first terminal electrically coupled to the emitter terminal of the first BJT and configured to receive the PTAT current; and
a second terminal electrically coupled to the drain terminal of the first PMOS and the positive input terminal of the operational amplifier;
a second BJT in a diode configuration comprising:
an emitter terminal electrically coupled to the negative input terminal of the operational amplifier, the drain terminal of the second PMOS, and configured to receive the PTAT current;
a base terminal; and
a collector terminal electrically coupled to the electrical ground reference;
a second resistor exhibiting the resistive value and comprising:
a first terminal electrically coupled to the base terminal of the second BJT; and
a second terminal electrically coupled to the electrical ground reference and the collector terminal of the second BJT.

15. The circuit of claim 14, wherein the first BJT and the second BJT exhibit the beta value.

16. The circuit of claim 14, wherein the reference BJT, the first BJT, and the second BJT are PNP type BJTs.

17. The circuit of claim 14, wherein the reference BJT, the first BJT, and the second BJT are manufactured using a complementary metal-oxide-semiconductor (CMOS) process.

18. The circuit of claim 13, wherein the reference resistor is a variable resistor.

19. A method for generating a process, voltage, and temperature invariant reference voltage, the method comprising:
generating a beta-compensated current based on a proportional to absolute temperature (PTAT) current, wherein the beta-compensated current is inversely proportional to a beta value of a reference bipolar junction transistor (BJT);
receiving at an emitter terminal of the reference BJT the beta-compensated current:
wherein the reference BJT comprises a base terminal, the emitter terminal, and a collector terminal, and
wherein a ratio of a collector current at the collector terminal and a base current at the base terminal is equal to the beta value; and
receiving the PTAT current at a first terminal of a reference resistive element, the reference resistive element comprising:
the first terminal; and
a second terminal electrically coupled to the emitter terminal of the reference BJT,
wherein the reference voltage is generated based on a voltage difference between the first terminal of the reference resistive element and the base terminal of the reference BJT.

20. The method of claim 19, wherein the reference resistive element is a variable resistor.
